(19) United States
(12) Patent Application Publication
(10) Pub. No.: US 2026/0356163 A1
(43) Pub. Date: Nov. 12, 2026

(54) LIQUID HEATER AND METHOD OF OPERATING SAME

(71) Applicant: Modine Manufacturing Company, Racine, WI (US)

(72) Inventors: Michael J. Kis, Racine, WI (US); Zachary John Fleischmann, Racine, WI (US)

(21) Appl. No.: 19/138,347

(22) PCT Filed: Dec. 27, 2024
(86) PCT No.: PCT/US2024/062047

§ 371 Date: Jun. 12, 2025

(51) Int. Cl. B60H 1/22; F24H 15/104; F24H 15/215; F24H 15/219; F24H 15/335; F24H 15/37

(52) U.S. Cl. CPC B60H 1/2218; B60H 1/2221; F24H 15/104; F24H 15/215; F24H 15/219; F24H 15/335; F24H 15/37

(57) ABSTRACT

A vehicle heater includes an inlet; an outlet; a fluid flowpath extending between the inlet and the outlet; a heating element configured to heat fluid flowing through the fluid flowpath; a controller configured to operate the heating element in response to receiving a power command; a first temperature sensor configured to sense temperature of the fluid adjacent the inlet; and a second temperature sensor configured to sense temperature of the fluid adjacent the outlet. The controller, in response to receiving the power command, ramps power to the heating element from a first power level to a second power level, monitors the first temperature sensor and second temperature sensor to detect a flow condition, and deactivates the heating element in response to detecting the flow condition.

### BACKGROUND

The present disclosure relates to vehicle components, and more specifically to heaters for heating liquid circulated throughout the vehicle. The heated liquid can be used, for example, as part of a system that provides cabin heating or as part of a system that provides heat to a vehicle battery.

### SUMMARY

In some embodiments, the heater described herein is configured to detect a low flow or no flow condition and deactivate the heating element before damage due to overheating can occur.

In one aspect, a vehicle heater includes an inlet; an outlet; a fluid flowpath extending between the inlet and the outlet; a heating element configured to heat fluid flowing through the fluid flowpath; a controller configured to operate the heating element in response to receiving a power command; a first temperature sensor configured to sense temperature of the fluid adjacent the inlet; and a second temperature sensor configured to sense temperature of the fluid adjacent the outlet. The controller is configured to: in response to receiving the power command, ramp power to the heating element from a first power level to a second power level, monitor the first temperature sensor and second temperature sensor to detect a flow condition, and deactivate the heating element in response to detecting the flow condition.

In another aspect combinable with any other aspect, the heating element of the vehicle heater is an electric heating element.

In another aspect combinable with any other aspect, the first power level is less than the second power level.

In another aspect combinable with any other aspect, the first power level is less than 50% of the second power level.

In another aspect combinable with any other aspect, the flow condition is a flow rate of the fluid between the inlet and outlet that is less than a desired flow rate.

In another aspect combinable with any other aspect, the flow condition is a flow rate of zero.

In another aspect combinable with any other aspect, the controller is configured to hold the power to the heating element at the first power level for a period of time prior to ramping the power to the heating element from the first power level to the second power level.

In another aspect combinable with any other aspect, the controller is configured to increase a ramp rate of the power to the heating element from the second power level to a requested power level compared to a ramp rate of power to the heating element from the first power level to the second power level.

In another aspect combinable with any other aspect, the controller is configured to increase a ramp rate of the power to the heating element from the first power level to the second power level at a predetermined power level that is greater than the first power level.

In another aspect combinable with any other aspect, the flow condition is indicated by the first temperature sensor indicating a higher temperature than the second temperature sensor.

In another aspect combinable with any other aspect, the flow condition is indicated by the second temperature sensor indicating a temperature that exceeds a temperature indicated by the first temperature sensor by at least a predetermined value.

In another aspect combinable with any other aspect, the vehicle heater includes a third temperature sensor configured to sense a temperature of the heating element.

In another aspect combinable with any other aspect, the flow condition is indicated by the temperature of the heating element indicated by the third temperature sensor increasing faster than the temperature of the fluid indicated by the second temperature sensor by at least a predetermined value.

In another aspect combinable with any other aspect, the controller is operatively connected to a pump that is configured to pass fluid through the vehicle heater in response to receiving the power command.

In another aspect combinable with any other aspect, a method for controlling a vehicle heater includes, in response to receiving the power command, ramping power to the heating element from a first power level to a second power level, monitoring the first temperature sensor and the second temperature sensor to detect a flow condition, and deactivating the heating element in response to detecting the flow condition.

In another aspect combinable with any other aspect, the flow condition is a flow rate of the fluid between the inlet and outlet that is less than a desired flow rate.

In another aspect combinable with any other aspect, the flow condition is indicated by the second temperature sensor indicating a temperature that exceeds a temperature indicated by the first temperature sensor by at least a predetermined value.

In another aspect combinable with any other aspect, the vehicle heater includes a third temperature sensor configured to sense a temperature of the heating element, and wherein the flow condition is indicated by the temperature of the heating element indicated by the third temperature sensor increasing faster than the temperature of the fluid indicated by the second temperature sensor by at least a predetermined value.

Other aspects of the invention will become apparent by consideration of the detailed description and accompanying drawings.

### BRIEF DESCRIPTION OF THE DRAWINGS

FIG. 1 is a schematic view of a vehicle heater.

FIG. 2 is a graph illustrating operation of the vehicle heater of FIG. 1 in the form of power vs. time.

FIG. 3 illustrates a method of operation of the vehicle heater of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Liquid heaters rely on adequate liquid flow through the heater to cool the control circuits and heating elements within the heater. One problem that exists in liquid heaters occurs when fluid flow is obstructed or stopped due to a system failure. If fluid flow is obstructed or stopped and the heating element within the heater is still active, damage due to overheating can occur. The temperature in the control circuit and heating element is a leading factor in the operating life of the heater, which is a critical customer requirement for heaters. A heater can be activated at the same time that the liquid is directed (for example, via a pump) through the heater. However, if the heating element within the heater is powered without adequate cooling flow, damage to the heater (e.g., at the heating element or control circuit within the heater) can occur. This damage can shorten operating life of the heater and/or critically damage the heater. A heater can address this problem by monitoring a temperature of the heating element and/or fluid within the heater, and turning off the heater if the measure temperature is too high. However, such a solution is inadequate as, in many cases, for the measured temperature to reach a critical value, damage to the heater has already occurred. Further, the heating element will continue to emit heat after the heating element is deactivated. As a result, instantaneous shutdown of the heating element does not immediately reduce temperature within the heater, so damage to the heater can still occur. One object of the devices and methods disclosed herein is to address this issue.

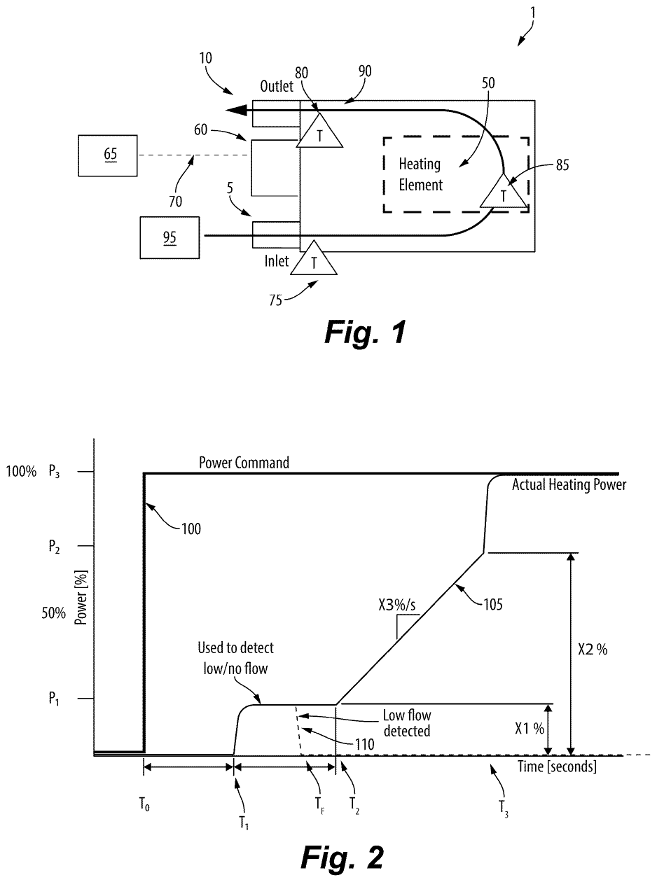

FIG. 1 is a schematic view of a heater 1, more specifically a heater for heating liquid in a vehicle, and depicts a fluid flow path therein. The heater 1 includes an inlet 5 and an outlet 10. Fluid is delivered to the inlet 5 for heating, and heated fluid flows out of the outlet 10 for use within the vehicle in which the heater 1 is installed. The heater 1 includes a fluid flowpath 90 extending from the inlet 5 to the outlet 10, and as fluid flows through the fluid flowpath 90, the fluid is heated by a heating element 50. The fluid flowpath 90 includes, in some examples, an inlet channel or manifold connected to the inlet 5, and an outlet channel or manifold connected to the outlet 10. The fluid flowpath 90 can additionally include heating channels, i.e., a series of smaller channels compared to the inlet and outlet channels, to direct the fluid over the heating element 50 thereby improving heat exchange from the heating element 50 to the fluid. In some examples, the heating channels form a U-shaped and/or circuitous path from the inlet channel to the outlet channel. In some examples, other flow elements, such as turbulator columns, studs, or bars, extend across the fluid flowpath 90 to create turbulence within the fluid as the fluid passes through the fluid flowpath 90. This turbulence increases heat exchange to the fluid and reduces cavitation in the fluid, thus providing better heater 1 performance.

The fluid is heated by the heating element 50, which in some examples is an electric heating element, in the approximate location of the box indicated by reference numeral 50 in FIG. 1. As fluid passes through the fluid flowpath 90, heat is conducted from the heating element, through the metal structure forming the fluid flowpath 90, and into the fluid passing through the heater 1. In the embodiment shown in FIG. 1 the fluid flowpath 90 is generally U-shaped from the inlet 5 to the outlet 10, although other layouts of the fluid flowpath 90 are contemplated.

In some examples, the heater 1 includes insulated-gate bipolar transistors (“IGBT's”) or other control elements. These elements can be positioned along the fluid flowpath 90 to provide heating and/or cooling thereto from the fluid passing through the fluid flowpath 90.

The heater 1 also includes electrical connections 60, which allow for electrical connections between the heater 1 and the vehicle to, for example, control the heater 1, provide power to the heating element 50, and facilitate electrical connections between the heater 1 components (e.g., IGBT's, temperature sensors, etc.) and a controller 65 located remote from the heater 1. The controller 65 can be connected to the heater 1 via electrical connection 70.

The heater 1 as shown in FIG. 1 includes first, second, and third temperature sensors 75, 80, 85 positioned along the fluid flowpath 90 to measure the temperature of the fluid as the fluid moves along the fluid flowpath 90. The first temperature sensor 75 is located adjacent the inlet 5, the second temperature sensor 80 is located adjacent the outlet 10, and the third temperature sensor 85 is located along the fluid flowpath 90, between the inlet 5 and the outlet 10. The third temperature sensor 85 is intended to read an approximate temperature of the heating element 50. A pump 95, which in some examples is also controlled by the controller 65, propels fluid from the inlet 5 to the outlet 10.

FIG. 2 illustrates a graph depicting operation of the vehicle heater 1 in the form of power vs. time. At T₀ a power command 100 is received by the controller 65. The power command 100 is received as a step function, so a request for 100% of a requested power level P₃ to be applied is received at To. In some examples, the requested power level P₃ is 100% of the power that the heating element 50 is able to apply. In other examples, the requested power P₃ is less than 100% of the power that the heating element 50 is able to apply. In some examples, the pump 95 is activated to propel the fluid through the heater 1 when the power command 100 is received. However, to protect the heater 1 if a fault condition occurs, the controller 65 applies a heating power 105 as depicted in FIG. 2 instead of instantaneously delivering the requested power level P₃. Thus, the heating power 105 illustrates the power applied to the heating element 50 by the controller 65 in response to the power command 100 being received. After a delay starting at T₀ when the request for power is received, at T₁ a first power level P₁ is applied to the heating element 50. The first power level P₁ is far less than the requested power level P₃, for example the first power level P₁ is less than 50% of the requested power level P₃. In some examples, the first power level P₁ is a fixed percentage X1 of a maximum power of the heater 1, regardless of the requested power level P₃. The first power level P₁ is held by the controller 65 from T₁ for a period of time, i.e., from T₁ to T₂, and can be a period of seconds to a minute or more. Ideally, the period of time is long enough to allow flow through the fluid flowpath 90 to stabilize. During the time period from T₁ to T₂ the controller 65 monitors for a flow condition that indicates a fault. Holding a constant power at the first power level P₁ in this time period allows the heater 1 to operate, and gives time for a fault to occur and be detected prior to heating power being increased, which brings a higher chance of heater 1 damage and/or failure if a fault were to occur.

If no flow condition indicating a fault is detected, then power is ramped from the first power level P₁ to a second power level P₂. The second power level P₂ can be expressed as a percentage of maximum power X2, and is greater than the first power level P₁. In some examples, the first power level P₁ is less than 50% of the second power level P₂. The second power level P₂ is higher than the first power level P₁ and is, for example, more than 50% of the requested power level P₃. During the time period from T₂ to T₃ the controller 65 continues to monitor for a flow condition indicating a fault. If no flow condition indicating a fault is detected from T₂ to T₃, then at T₃ power is increased to the requested power level P₃. In some examples, a ramp rate is X3, and is expressed as a percent change in power per second (%/s). The ramp rate X3 of the power between the second power level P₂ and the requested power level P₃ is higher than the ramp rate of the power between the first power level P₁ and the second power level P₂. In some examples, power is increased quickly between the second power level P₂ and the requested power level P₃, similar to the rate at which power is increased from zero to the first power level P₁. In both cases, the rate of power increase can be the maximum rate that power can be applied to the heating element 50. In contrast, the rate X3 is slower, as indicated by the smaller slope of the heating power 105 line between times T₂ to T₃ compared to the slope of the heating power 105 immediately after T₁ and immediately after T₃ .By slowly increasing heating power from the first power level P₁ to the second power level P₂, the heater 1 is allowed to operate to give time for a flow condition indicating a fault to occur prior to heating power being increased to the requested power level P₃, which brings a higher chance of heater 1 damage and/or failure if a fault were to occur.

If the controller detects a flow condition indicating a fault at any point after T₁, for example at time T_{F} shown in FIG. 2, then the heating element 50 is immediately deactivated by the controller 65 to protect the heater 1 from overheating, which can lead to damage and failure of the heater 1. The power resulting from shutting down the heating element 50 at T_{F} is shown by the line 110 in FIG. 2. Although the time T_{F} is shown between T₁ to T₂ in FIG. 2, the resulting line 110 would be similar, e.g., illustrating power dropping to zero, if the flow condition indicating a fault were detected any time after T₂.

A flow condition indicating a fault occurs when the flow rate of the fluid between the inlet 5 and the outlet 10 is less than a desired flow rate. In some examples, a flow rate of zero indicates a fault. In other examples, the flow rate that indicates the fault is more than zero, but still less than a desired flow rate. The flow rate of the fluid, in some examples, is derived from temperature readings from the first temperature sensor 75 and the second temperature sensor 80.

For example, if the first temperature sensor 75 (i.e., the sensor adjacent the inlet 5) indicates a temperature that is higher than the temperature indicated by the second temperature sensor 80 (i.e., the sensor adjacent the outlet 10), a fault exists because temperature of the fluid should increase from the inlet 5 to the outlet 10. In another example, a fault exists if the second temperature sensor 80 indicates a temperature that is much higher than the temperature indicated by the first temperature sensor 75. A fault exists in this condition because there is a limit to how much heat the heater 1 can apply to the fluid during normal operation. If this limit is exceeded, then the fluid is likely flowing at less than the desired rate so that the increased heating can occur. In another example of a flow condition indicating a fault, the temperature of the heating element 50 indicated by the third temperature sensor 85 is increasing faster than the temperature of the fluid indicated by the second temperature sensor 80 by at least a predetermined value. In this condition, heat is not properly passing from the heating element 50 to the fluid, which results in heat being detected by the third temperature sensor 85 that is not sensed by the second temperature sensor 80. As a result, a fault has likely occurred that prevents fluid heated by the heating element 50 to pass from the heating element 50 through the outlet 10 at the proper rate.

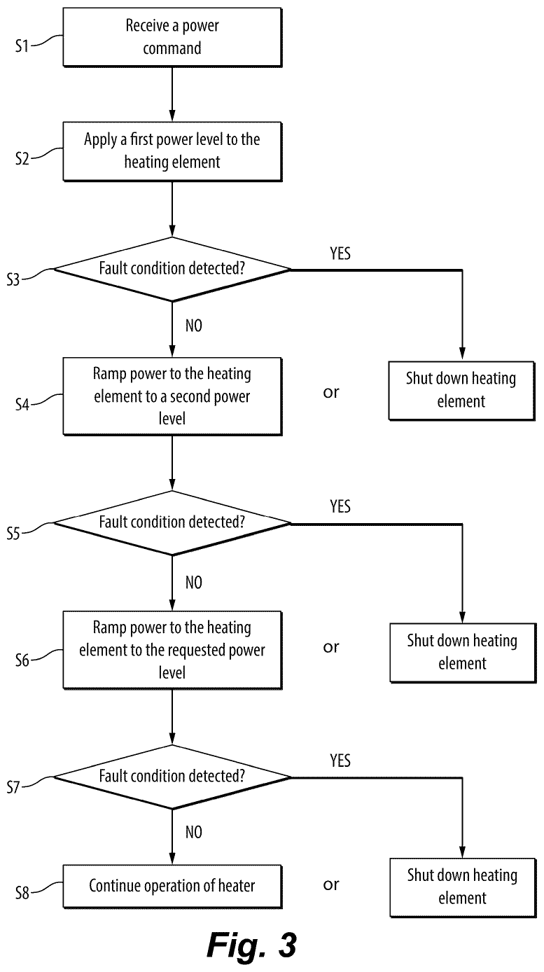

FIG. 3 is a diagram illustrating a method for controlling the heater 1. At step S1, the controller 65 receives a power command indicating that heated fluid is desired by the vehicle.

The controller 65 correlates the power command to a requested power level P₃. The requested power level P₃ can be any power level that the heating element 50 is able to apply, including 100% power. In some embodiments, the pump 95 begins circulating fluid through the fluid flowpath 90 when the power command is received.

Then, at step S2, the controller 65 applies a first power level P₁ to the heating element 50. The temperature of the heating element 50 rises. The first power level P₁ is held for a period of time, for example from T₁ to T₂ as shown in FIG. 2. Simultaneous with step 2, step S3 occurs. In step S3, the controller 65 monitors the data from at least one of the first, second, and third temperature sensors 75, 80, 85 to detect a flow condition indicating a fault has occurred.

At step S4, if a flow condition indicating a fault has occurred, then the controller 65 shuts down the heating element 50 by removing power from the heating element 50. In some examples, all power is removed from the heating element 50. In some examples, power is immediately removed from the heating element 50 to reduce the temperature of the heating element 50 as soon as possible. However, if no flow condition indicating a fault is detected, then the controller 65 ramps the heating element to a second power level P₂. In some examples, power is ramped from the first power level P₁ to the second power level P₂ at a constant rate X3, thus resulting in the constant slope of the heating power 105 between T₂ and T₃ shown in FIG. 2.

As the controller 65 ramps the heating element to the second power level P₂, the fifth step S5 is performed. In step S5, the controller 65 monitors the data from at least one of the first, second, and third temperature sensors 75, 80, 85 to detect a flow condition indicating a fault has occurred.

The, at step S6, if a flow condition indicating a fault has occurred, then the controller 65 shuts down the heating element 50 by removing power from the heating element 50. The controller 65 can shut down the heating element 50 in the same ways the controller 65 can shut down the heating element 50 listed in step S4. However, if no flow condition indicating a fault is detected, then the controller 65 ramps the heating element 50 to the requested power level P₃. In some examples, the controller 65 ramps the heating element 50 to the requested power level P₃ quickly, resulting in the relatively steep slope of the heating power 105 between T₃ and T₄ shown in FIG. 2, as compared to the slope of the heating power 105 between times T₂ and T₃.

As the controller 65 ramps the heating element to the requested power level P₃, the seventh step S7 is performed. In step S7, the controller 65 monitors the data from at least one of the first, second, and third temperature sensors 75, 80, 85 to detect a flow condition indicating a fault has occurred. As indicated in Step S8, if a flow condition exists that indicates a fault has occurred, the heating element 50 is shut down like in steps S4 and S6. However, if no flow condition indicating a fault has been detected, then the heater 1 will continue normal operation at the requested power level P₃ until a flow condition indicating a fault has been detected, or in other examples, until a new requested power level that is higher than P3, lower than P3, or zero is received by the controller 65. In general, at this point the start-up routine of the heater 1 is finished, and the heater 1 is operated according to normal operation of the vehicle heater 1.

The systems and methods set forth herein provide distinct advantages over known heater systems. By detecting flow rate using only the first temperature sensor 75, the second temperature sensor 80, and the third temperature sensor 85, a no flow or low flow condition within the heater 1 can be detected prior to damage occurring, and without adding significant additional complexity and cost to the heater 1 system. For example, significant cost and complexity is avoided by measuring flow using only temperature sensors, without need to a more complex and expensive flow sensor. Further, by holding power at the first power level P₁ to allow a fully formed flow condition to develop and relatively slowly increasing power to the power level P₂, a low or no flow condition can be detected prior to significant damage, for example from heat soak, occurring to the heater 1.

There are at times unavoidable interruptions in coolant flow due to the nature of any liquid heater application. The accumulative damage and resulting effect on remaining heater 1 life may be determined by the controller recording the operating conditions when an interruption to coolant flow occurred. By characterizing the effect of different flow interruptions on overall heater 1 life, these operating conditions can be used to predict remaining heater 1 life. In some examples, the controller 65 can log this data and uses it as part of a predictive analysis algorithm to alert an end user when preventative maintenance needs to be performed to avoid downtime in the end user application, such as within a vehicle.

Various additional features and advantages of the invention are shown in the figures, which illustrate a to-scale version of some embodiments of the invention.

What is claimed is:

1. A vehicle heater comprising:
an inlet;
an outlet;
a fluid flowpath extending between the inlet and the outlet;
a heating element configured to heat fluid flowing through the fluid flowpath;
a controller configured to operate the heating element in response to receiving a power command;
a first temperature sensor configured to sense temperature of the fluid adjacent the inlet; and
a second temperature sensor configured to sense temperature of the fluid adjacent the outlet;
wherein the controller is configured to:
in response to receiving the power command, ramp power to the heating element from a first power level to a second power level,
monitor the first temperature sensor and second temperature sensor to detect a flow condition, and
deactivate the heating element in response to detecting the flow condition.

2. The vehicle heater of claim 1, wherein the heating element is an electric heating element.

3. The vehicle heater of claim 1, wherein the first power level is less than the second power level.

4. The vehicle heater of claim 3, wherein the first power level is less than 50% of the second power level.

5. The vehicle heater of claim 1, wherein the flow condition is a flow rate of the fluid between the inlet and outlet that is less than a desired flow rate.

6. The vehicle heater of claim 5, wherein the flow rate of the fluid is zero.

7. The vehicle heater of claim 6, wherein the controller is configured to hold the power to the heating element at the first power level for a period of time prior to ramping the power to the heating element from the first power level to the second power level.

8. The vehicle heater of claim 7, wherein the controller is configured to increase a ramp rate of the power to the heating element from the first power level to the second power level as the power to the heating element ramps from the first power level.

9. The vehicle heater of claim 7, wherein the controller is configured to increase a ramp rate of the power to the heating element from the second power level to a requested power level compared to a ramp rate of power to the heating element from the first power level to the second power level.

10. The vehicle heater of claim 1, wherein the flow condition is indicated by the first temperature sensor indicating a higher temperature than the second temperature sensor.

11. The vehicle heater of claim 1, wherein the flow condition is indicated by the second temperature sensor indicating a temperature that exceeds a temperature indicated by the first temperature sensor by at least a predetermined value.

12. The vehicle heater of claim 11 further comprising a third temperature sensor configured to sense a temperature of the heating element.

13. The vehicle heater of claim 12, wherein the flow condition is indicated by the temperature of the heating element indicated by the third temperature sensor increasing faster than the temperature of the fluid indicated by the second temperature sensor by at least a predetermined value.

14. The vehicle heater of claim 1, wherein the controller is operatively connected to a pump that is configured to pass the fluid through the vehicle heater in response to receiving the power command.

15. A method for controlling a vehicle heater, the vehicle heater comprising:
an inlet;
an outlet;
a fluid flowpath extending between the inlet and the outlet;
a heating element configured to heat fluid flowing through the fluid flowpath;
a controller configured to operate the heating element in response to receiving a power command;
a first temperature sensor configured to sense temperature of the fluid adjacent the inlet; and
a second temperature sensor configured to sense temperature of the fluid adjacent the outlet;
the method including:
in response to receiving the power command, ramping power to the heating element from a first power level to a second power level,
monitoring the first temperature sensor and the second temperature sensor to detect a flow condition, and
deactivating the heating element in response to detecting the flow condition.

16. The method for controlling a vehicle heater of claim 15, wherein the first power level is less than the second power level.

17. The method for controlling a vehicle heater of claim 15, wherein the flow condition is a flow rate of the fluid between the inlet and outlet that is less than a desired flow rate.

18. The method for controlling a vehicle heater of claim 17, wherein the flow condition is indicated by the first temperature sensor indicating a higher temperature than the second temperature sensor.

19. The method for controlling a vehicle heater of claim 17, wherein the flow condition is indicated by the second temperature sensor indicating a temperature that exceeds a temperature indicated by the first temperature sensor by at least a predetermined value.

20. The method for controlling a vehicle heater of claim 17, wherein the vehicle heater includes a third temperature sensor configured to sense a temperature of the heating element, and wherein the flow condition is indicated by the temperature of the heating element indicated by the third temperature sensor increasing faster than the temperature of the fluid indicated by the second temperature sensor by at least a predetermined value.
